(19) United States
(12) Patent Application Publication
(10) Pub. No.: US 2018/0143630 A1
(43) Pub. Date: May 24, 2018

(54) PATH PLANNING FOR AUTONOMOUS VEHICLE USING BIDIRECTIONAL SEARCH

(71) Applicants: Mohsen Rohani, Gatineau (CA); Song Zhang, Ottawa (CA)

(72) Inventors: Mohsen Rohani, Gatineau (CA); Song Zhang, Ottawa (CA)

(21) Appl. No.: 15/356,207

(22) Filed: Nov. 18, 2016

(51) Int. Cl. G05D 1/00; G05D 1/02

(52) U.S. Cl. CPC G05D 1/0088; G05D 1/0278; G05D 1/024; G05D 1/0246; G05D 1/0257

(57) ABSTRACT

Methods and systems for path planning in an autonomous vehicle. Data representing an environment of the vehicle is received. A searchable map of the environment is generated using the received data. A bidirectional search of the searchable map is performed to determine a planned path from a first point in the searchable map to a second point in the searchable map, where the first point represents a first state of the vehicle and the second point represents a target state of the vehicle. Output is generated including data defining the planned path.

### FIELD

The present disclosure relates to methods and systems for autonomous vehicles. In particular, the present disclosure relates to path planning in autonomous vehicles.

### BACKGROUND

Autonomous vehicles require path planning to determine the appropriate path for the vehicle to take. Path planning is performed in real-time to enable the vehicle to react to changes in the environment. Increasing the number of parameters to be considered for path planning helps to increase the reliability, robustness and/or adaptiveness of the autonomous vehicle. As the parameters to be considered increases, the search space in which to search for a suitable path also increases. Path planning approaches that search for a suitable path in the search space need to be fast enough to provide path planning on a timescale that allows the autonomous vehicle to adequately respond rapidly to the changing environment.

### SUMMARY

In various examples described herein, methods and systems for path planning for autonomous vehicles using bidirectional search are described. Using bidirectional search can reduce the number of operations performed in path planning, compared to conventional approaches, and may thus enable a greater number of parameters to be considered in practical implementations for autonomous vehicles.

By enabling a greater number of parameters to be considered in path planning, examples described herein may provide greater flexibility in path planning, and may thus enable an autonomous vehicle to determine a more robust and reliable path to travel. Further, the use of bidirectional search in path planning may help to speed up the path planning process, enabling the autonomous vehicle to react and re-plan more rapidly in a changing environment. This may help to increase the safety of the passenger as well as bystanders.

In some examples, the present disclosure describes a method for path planning in an autonomous vehicle. Data representing an environment of the vehicle are received. A searchable map of the environment is generated using the received data. A bidirectional search of the searchable map is performed to determine a planned path from a first point in the searchable map to a second point in the searchable map. The first point represents a first state of the vehicle and the second point represents a target state of the vehicle. Output is generated including data defining the planned path.

In some examples, the present disclosure describes a system for path planning in an autonomous vehicle. The system includes a processor configured to execute instructions to cause the system to receive data representing an environment of the vehicle. The instructions further cause the system to generate a searchable map of the environment using the received data. The instructions further cause the system to perform a bidirectional search of the searchable map to determine a planned path from a first point in the searchable map to a second point in the searchable map. The first point represents a first state of the vehicle and the second point represents a target state of the vehicle. The instructions further cause the system to generate output including data defining the planned path.

In some examples, the present disclosure describes a system for path planning in an autonomous vehicle. The system includes a software module to generate a searchable map of the environment using the received data. The system further includes a software module to perform a bidirectional search of the searchable map to determine a planned path from a first point in the searchable map to a second point in the searchable map. The first point represents a first state of the vehicle and the second point represents a target state of the vehicle. The system further includes a software module to generate output including data defining the planned path.

In some examples, the present disclosure describes a vehicle. The vehicle includes one or more sensors for obtaining data representing an environment of the vehicle. The vehicle also includes a path planning system for generating a planned path to be travelled by the vehicle. The vehicle also includes a vehicle control system for controlling operation of the vehicle. The path planning system is implemented by a processor executing instructions to cause the path planning system to receive, from the one or more sensors, data representing an environment of the vehicle. Such reception of data may be carried out by a data reception module of the path planning system. The instructions further cause the path planning system to generate a searchable map of the environment using the received data. Such map generation may be carried out by a map generation module of the path planning system. The instructions further cause the path planning system to perform a bidirectional search of the searchable map to determine a planned path from a first point in the searchable map to a second point in the searchable map. The first point represents a first state of the vehicle and the second point represents a target state of the vehicle. The instructions further cause the path planning system to provide, to the vehicle control system, output including data defining the planned path. Such a search may be carried out by a bidirectional search module of the path planning system.

### BRIEF DESCRIPTION OF THE DRAWINGS

Reference will now be made, by way of example, to the accompanying drawings which show example embodiments of the present application, and in which:

FIG. 1 is a block diagram showing components of an example autonomous vehicle;

FIG. 2 illustrates an example of mission planning;

FIG. 3 illustrates an example of behaviour planning;

FIG. 4 illustrates an example of motion planning;

FIG. 5 shows an example searchable grid map of an environment surrounding an autonomous vehicle;

FIG. 6 shows an example result of path planning using A* search in the map of FIG. 5;

FIG. 7 shows an example result of path planning using bidirectional search in the map of FIG. 5; and

FIG. 8 is a flowchart illustrating an example method for path planning.

Similar reference numerals may have been used in different figures to denote similar components.

### DESCRIPTION OF EXAMPLE EMBODIMENTS

Although examples described herein refer to a car as the autonomous vehicle, the teachings of the present disclosure may be implemented in other forms of autonomous vehicles including, for example, trucks, buses, boats, aircraft, warehouse equipment, construction equipment, farm equipment, and may include vehicles that do not carry passengers as well as vehicles that do carry passengers. The methods and systems for path planning disclosed herein may also be suitable for implementation in non-vehicular mobile robots, for example autonomous vacuum cleaners and lawn mowers.

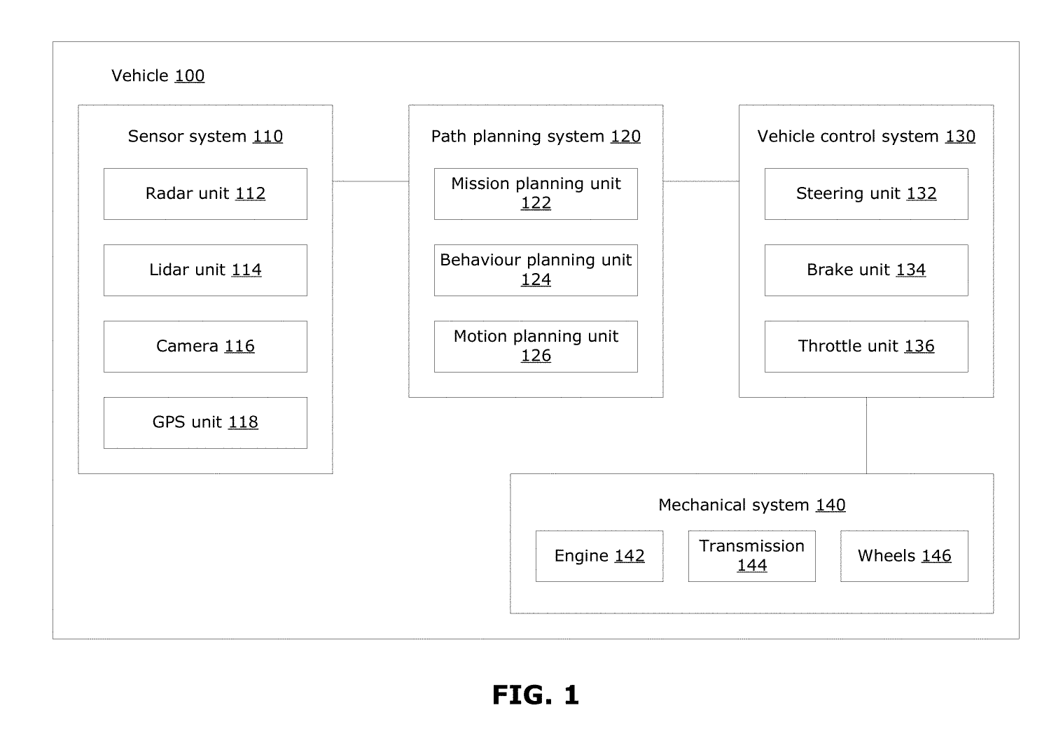

FIG. 1 is a block diagram illustrating certain components of an example autonomous vehicle 100. Although described as being autonomous, the vehicle 100 may be operable in a fully-autonomous, semi-autonomous or fully user-controlled mode. In the present disclosure, the vehicle 100 is described in the embodiment of a car. The vehicle 100 includes a sensor system 110, a path planning system 120, a vehicle control system 130 and a mechanical system 140, for example. Other systems and components may be included in the vehicle 100 as appropriate. The sensor system 110 may communicate with the path planning system 120, the path planning system 120 may communicate with the vehicle control system 130, and the vehicle control system 130 may communicate with the mechanical system 140. Other communications between systems and components may be suitable.

The sensor system 110 includes various sensing units for collecting information about the environment of the vehicle 100. In the example shown, the sensor system 110 includes a radar unit 112, a lidar unit 114, a camera 116 and a global positioning system (GPS) unit 118. The camera 116 may capture static and/or video images, for example. Using the appropriate sensing unit 112, 114, 116, 118, the sensor system 110 may collect information about the local environment of the vehicle 100 (e.g., any immediately surrounding obstacles) as well as information from a wider vicinity (e.g., the radar unit 112 and lidar unit 114 may collect information from an area of up to 100 m radius around the vehicle 100). The sensor system 110 may also collect information about the position and orientation of the vehicle 100 relative to a frame of reference (e.g., using the GPS unit 118). The sensor system 110 may further collect information about the vehicle 100 itself. In such a case, the vehicle 100 may itself be considered part of the sensed environment. For example, the sensor system 110 may collect information from sensing units (e.g., accelerometers), which may or may not be part of the sensor system 110, to determine the linear speed, angular speed, acceleration and tire grip of the vehicle 100.

In some examples, the sensor system 110 may include or may communicate with an object recognition system (not shown) to identify any sensed objects, for example to identify a stop sign or a traffic light. The sensor system 110 communicates information from the sensed environment (including information about the vehicle 100 in some cases) to the path planning system 120. The information communicated to the path planning system 120 may be provided as raw data collected by the sensor system 110, or may have been processed by the sensor system 110. For example, the sensor system 110 may process data collected from the radar unit 112, lidar unit 114 and camera 116 to determine the location and dimensions of an obstacle, and provide this processed data to the path planning system 120. The sensor system 110 may further process the data to identify the obstacle, for example to identify a stop sign, and provide this identification data to the path planning system 120. The sensor system 110 may also detect drivable ground (e.g., paved roadway) that the vehicle 100 can drive on.

The sensor system 110 may repeatedly (e.g., in regular intervals) receive information from its sensing units in real-time. The sensor system 110 may in turn provide information to the path planning system 120 in real-time or near real-time.

The path planning system 120 carries out path planning for the vehicle 100. In the example shown, the path planning system 120 includes a mission planning unit 122, a behaviour planning unit 124 and a motion planning unit 126. Each of these units 122, 124, 126 may be implemented as software modules or control blocks within the planning system 120. The result of path planning by the units 122, 124, 126 may be communicated among each other, as discussed further below. Although illustrated as three separate components, the mission planning unit 122, behaviour planning unit 124 and motion planning unit 126 may be implemented in fewer or greater number of components. For example, a single computing unit may carry out all the functions of the units 122, 124, 126 using a single software module. Generally, the functions of the path planning system 120 may be carried out by a single processor or may be spread over two or more processors. Details of the functions of the path planning system 120 and each of the units 122, 124, 126 are discussed further below.

The output from the path planning system 120 includes a set of data defining one or more planned paths, as discussed further below. The path planning carried out by the path planning system 120 is performed in real-time or near real-time, to enable the vehicle 100 to be responsive to real-time changes in the environment. The data defining the planned path(s) is communicated to the vehicle control system 130.

The vehicle control system 130 serves to control operation of the vehicle 100. In the example shown, the vehicle control system 130 includes a steering unit 132, a brake unit 136 and a throttle unit 136. Each of these units 132, 134, 136 may be implemented as software modules or control blocks within the vehicle control system 130. The units 132, 134, 136 process the planned path information received from the path planning system 120 and generate control signals to control the steering, braking and throttle, respectively, of the vehicle 100 in order to achieve the planned path. The vehicle control system 130 may include additional components to control other aspects of the vehicle 100 including, for example, control of turn signals and brake lights.

The mechanical system 140 receives control signals from the vehicle control system 130 to operate the mechanical components of the vehicle 100. The mechanical system 140 effects physical operation of the vehicle 100. In the example shown, the mechanical system 140 includes an engine 142, a transmission 144 and wheels 146. The engine 142 may be a gasoline-powered engine, an electricity-powered engine, or a gasoline/electricity hybrid engine, for example. Other components may be included in the mechanical system 140, including, for example, turn signals, brake lights, fans and windows.

The vehicle 100 may include other components that are not shown, including, for example, a user interface system and a wireless communication system. These other components may also provide input to and/or receive output from the above-described systems. The vehicle 100 may also communicate with an external system, for example an external map database.

The sensor system 110, path planning system 120 and the vehicle control system 130 may be individually or in combination be realized, at least in part, in one or more computing units of the vehicle 100. For example, the vehicle 100 may include a computing unit having one or more physical processors coupled to one or more tangible memories. The memory(ies) may store instructions, data and/or software modules for execution by the processor(s) to carry out the functions of the systems 110, 120, 130. The memory(ies) may store other software instructions and data for implementing other operations of the vehicle 100. The systems 110, 120, 130, 140 may communicate wirelessly or in a wired fashion.

Functions of the path planning system 120 are now described in more detail. Generally, path planning may be performed at three levels, namely at the mission level (e.g., performed by the mission planning unit 122), at the behavior level (e.g., performed by the behaviour planning unit 124) and at the motion level (e.g., performed by the motion planning unit 126).

Generally, the purpose of path planning is to determine a path for the vehicle 100 to travel from a first state (e.g., defined by the vehicle's current position and orientation, or an expected future position and orientation) to a target state (e.g., a final destination defined by the user). Path planning may also include determining one or more sub-paths to one or more intermediate target states. The path planning system 120 determines the appropriate path and sub-paths with consideration of conditions such as the drivable ground (e.g., defined roadway), obstacles (e.g., pedestrians and other vehicles), traffic regulations (e.g., obeying traffic signals) and user-defined preferences (e.g., avoidance of toll roads).

Path planning by the path planning system 120 may be dynamic, and be repeatedly performed as the environment changes. Changes in the environment may be due to movement of the vehicle 100 (e.g., vehicle 100 approaches a newly-detected obstacle) as well as due to the dynamic nature of the environment (e.g., moving pedestrians and other moving vehicles). Information from the sensor system 110 may be converted to form a searchable map of the vehicle's environment, and this searchable map may then be used for path planning. For example, the searchable map may be in the form of a grid representation, graph representation or any other form suitable for describing the environment and suitable for searching using an appropriate search approach.

The searchable map may also incorporate digital geographical map information (e.g., from satellite maps or stored maps in an internal or external database), such as information about drivable areas (e.g., road condition, location of parking lots, presence of road tolls), as searchable parameters. The path planning system 120 may also receive information from an external system (e.g., via wireless communication) about real-time traffic conditions, for example, and incorporate this information into the searchable map. For example, the path planning system 120 may receive and share sensed data and/or planned path data with other vehicles. The movement direction and speed of moving obstacles may also be represented in the searchable map. In some examples, predicted motion or location of moving obstacles may also be represented in the searchable map. Generally, the searchable map may represent not just geographical information (as in conventional geographical maps) but also may represent additional parameters (e.g., angular speed, linear speed, linear acceleration and/or angular acceleration) to be considered in path planning.

Path planning may be carried out using a multi-parameter search of the searchable map. The search space may include parameters such as position, speed, acceleration, time, orientation and angular speed of the vehicle 100, as well as other appropriate parameters. Each addition of a parameter to be considered results in an additional dimension of the search space.

As mentioned above, path planning may be performed at different levels, for example at the mission level, behaviour level and motion level. Mission level path planning is considered to be a higher (or more global) level of path planning, motion level path planning is considered to be a lower (or more localized) level of path planning, and behaviour level path planning is considered to be between mission and motion level. Generally, the output of path planning at a higher level may form at least part of the input for a lower level of path planning.

At each level of planning, the planned path may be defined as a series of points, each point defining a planned target position (e.g., x- and y-coordinates) of the vehicle 100. Each point may additional define the planned speed, orientation, acceleration and/or angular speed of the vehicle 100, thus defining the planned state of the vehicle 100 at each target position. The planned path may thus define a set of locations (or more generally, a set of states) to be travelled by the vehicle 100 in the planned journey.

Path planning at the mission level (more simply referred to as mission planning) relates to planning a path for the autonomous vehicle at a high, or global, level. The first state of the vehicle 100 may be the starting point of the journey (e.g., the user's home) and the target state of the vehicle 100 may be the final destination point (e.g., the user's workplace). Selecting a route to travel through a set of roads is an example of mission planning. Generally, the final destination point, once set (e.g., by user input) is unchanging through the duration of the journey. Although the final destination point may be unchanging, the path planned by mission planning may change through the duration of the journey. For example, changing traffic conditions may require mission planning to dynamically update the planned path to avoid a congested road. The user may also change the final destination point at any time during the journey.

Input data for mission planning may include, for example, GPS data (e.g., to determine the starting point of the vehicle 100), geographical map data (e.g., from an internal or external map database), traffic data (e.g., from an external traffic condition monitoring system), the final destination point (e.g., defined as x- and y-coordinates, or defined as longitude and latitude coordinates), as well as any user-defined preferences (e.g., preference to avoid toll roads). A searchable map for mission planning may be generated (e.g., using a suitable method for generation of a searchable grid or searchable graph) based on the input data. A bidirectional search is performed in the searchable map to generate the planned path from the starting point to the final destination point.

The planned path output from mission planning defines the route to be travelled to reach the final destination point from the starting point. The output may include data defining a set of intermediate target states (or waypoints) along the route. The intermediate target states may be defined at road intersections to indicate which road to take at each intersection, for example. The intermediate target states may be used for path planning at the behaviour level. The intermediate target states may also be used to facilitate more efficient real-time mission planning when detours are encountered, for example.

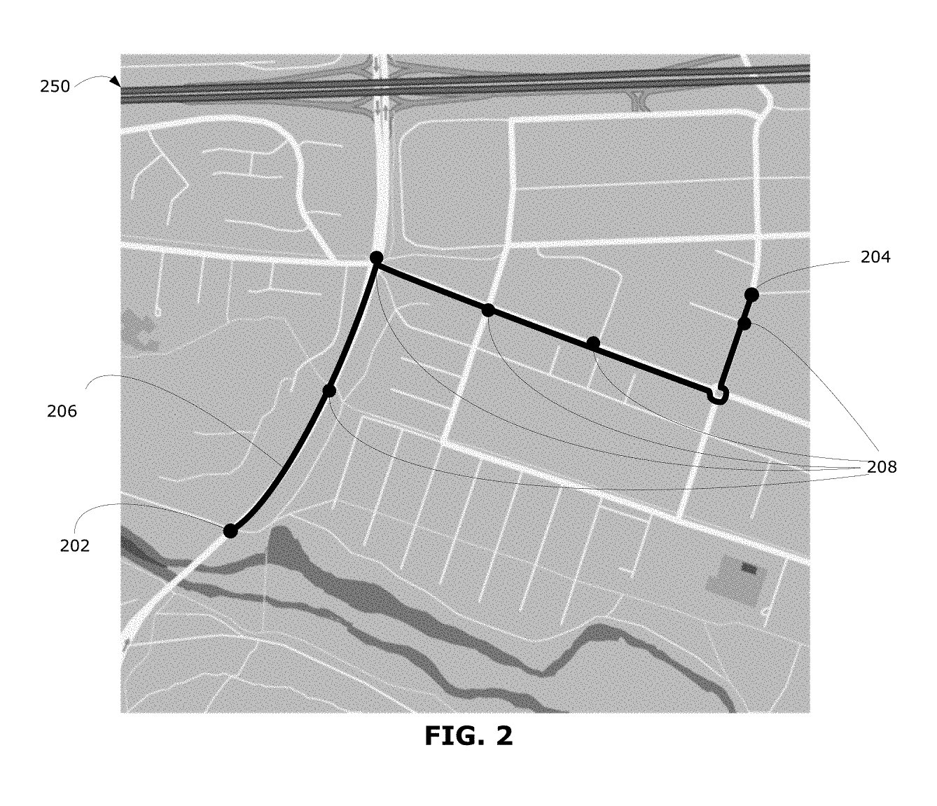

FIG. 2 illustrates an example of mission planning, which may be carried out by the path planning system 120 (e.g., using the mission planning unit 122). In this example, the first state 202 of the vehicle 100 is the starting point of the journey and the target state 204 of the vehicle 100 is the final destination of the journey. The first state 202 and target state 204 may be defined as x- and y-coordinates in a geographical map 250, which may be obtained from an internal or external database. FIG. 2 shows the planned path 206 from the first state 202 to the target state 204, as well as multiple intermediate target states 208 along the planned path 206. In this example, the intermediate target states 208 are defined at road intersections; however, intermediate target states 208 may be defined at non-intersection locations along the planned path 206.

Path planning at the behaviour level (more simply referred to as behaviour planning) relates to planning a sub-path for the autonomous vehicle 100 at an intermediate, or neighbourhood, level. In the present disclosure, the term “path” may be generally used to refer to both the complete path taken from starting point to final destination of a journey, as well as sub-paths within the full path. Behaviour planning generally is carried out based on consideration of traffic regulations in the sensed environment. For example, the behaviour planning unit 124 may include or may communicate with a database that define appropriate vehicle behaviour in accordance with traffic regulations (e.g., vehicle must take the rightmost lane when performing a right turn).

Input data for behaviour planning may include, for example, data defining the planned path from the mission planning level. For example, the mission planning unit 122 may communicate a set of data defining the planned path, including intermediate target states, to the behaviour planning unit 124. Input data may also include data about the sensed environment, from the sensor system 110. A searchable map may be generated based on this input data. In some examples, a searchable map may not be used for behaviour planning, and instead behaviour planning may be based on a set of predefined rules (e.g., logic and traffic rules). Behaviour planning may then be carried out to generate the sub-path for the vehicle 100 to take in order to reach the next intermediate target state, and obey applicable traffic regulations.

The result of behaviour planning defines a sub-path to be travelled by the vehicle 100 to reach the next intermediate target state in the overall planned path (as defined by mission planning). The output from behavior planning may include data defining a second set of intermediate target states along the sub-path. The second set of intermediate target states defined by behaviour planning may be more geographically specific than the first set of intermediate target states defined by mission planning. For example, mission planning may determine that the vehicle 100 should turn onto a particular road, and behaviour planning may determine that the vehicle 100 should take the rightmost lane in order to turn right onto that road. The second set of intermediate target states may be used for path planning at the motion level.

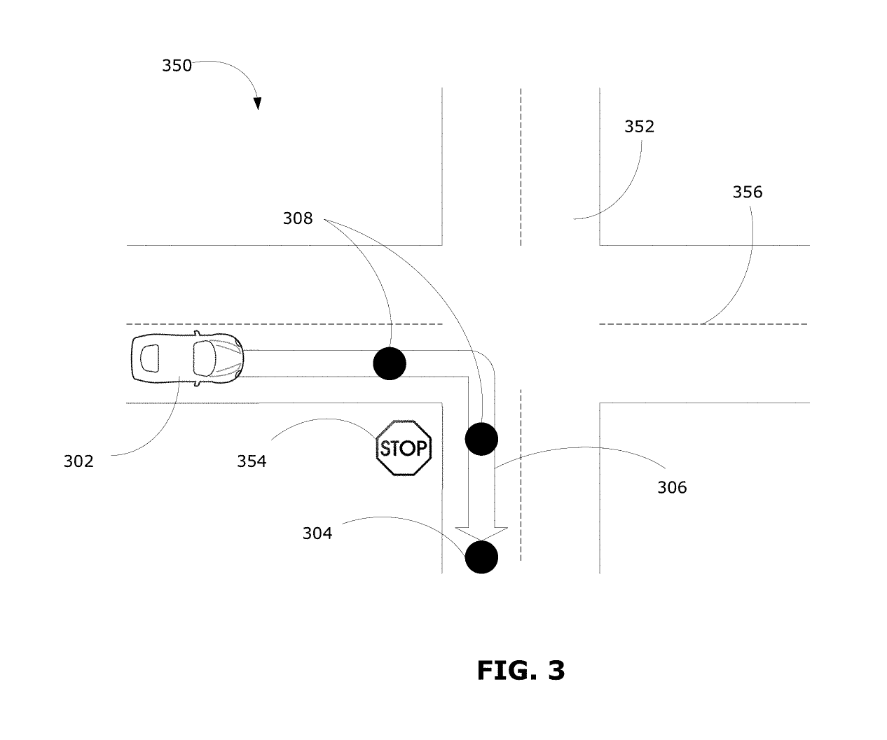

FIG. 3 illustrates an example of behaviour planning, which may be carried out by the path planning system 120 (e.g., using the behaviour planning unit 124). In this example, the target state 304 has been defined. For example the target state 304 may be the next intermediate state in the planned path defined by mission planning. The first state 302 of the vehicle 100 may be the current state of the vehicle 100, as determined by the sensor system 110 (e.g., using the GPS unit 118). The first state 302 may be defined not only as a position (e.g., x- and y-coordinates, or identifier of the current lane and/or street of the vehicle 100) but may also be defined by other parameters, such as the speed, orientation, acceleration and/or angular speed of the vehicle 100. The target state 304 may be similarly defined.

In the example shown, the sensed environment 350 includes the sensed drivable area, such as the paved roadway 352, as well as road signage and markings, such as a stop sign 354 and lane markings 356. Behaviour planning is carried out by the path planning system 120 to determine that the vehicle 100 should obey the stop sign 354, then take the rightmost lane to turn right to continue on the paved roadway 352 towards the target state 304. FIG. 3 illustrates that behaviour planning has generated a planned sub-path 306 necessary to reach the target state 304, and additionally a second set of intermediate states 308 to guide the vehicle 100 into the rightmost lane for the right turn, and to remain in the rightmost lane after turning right.

Path planning at the motion level (more simply referred to as motion planning) relates to planning a path for the autonomous vehicle at a low, or localized, level. Motion planning is used to determine how the vehicle 100 should move in its immediate environment (e.g., whether it is currently safe for the vehicle 100 to change lanes).

Input data for motion planning may include, for example, the second set of intermediate states generated by behavior planning and possible also the first set of intermediate states generated by mission planning. Information about the vehicle's environment (which in some cases may include information about the vehicle itself) is also included in the input data. This information about the environment may at least partly be provided by the sensor system 110. This information about the environment may also provide information about the current state of the vehicle 100 (e.g., current location, speed, orientation and acceleration). This information about the environment may include information about immediate obstacles (e.g., up to a radius of about 100 m from the vehicle 100, depending on the capabilities of the sensor system 110), and may further include information identifying the obstacles and/or information about the predicted behaviour of the obstacles (e.g., information about whether another moving vehicle is expected to stop moving). A searchable map is generated based on this input data, representing drivable areas, non-drivable areas and obstacles to avoid, for example. A bidirectional search is carried out in the searchable map to determine the planned path for the vehicle 100 in the immediate environment, in order to reach the target state.

In motion planning, the target state may be the next intermediate state along the path, as defined by behavior planning or mission planning. In some examples, the target state may be defined during motion planning to be a point further along the planned path (as defined by behavior planning or mission planning). For example, the target state may be defined as a point at a predefined distance (e.g., 100 m) further down the planned path from the current position. The target state may be updated at each instance of motion planning, such that the target state is always at the predefined distance further down the planned path.

Motion planning outputs a set of data defining the motion the vehicle 100 is to take in the immediate environment, to reach the target state. The set of data may include, for example, a series of data points, each data point defining the planned position of the vehicle 100 (e.g., as x- and y-coordinates) at each time point (e.g., at each 100 ms). The interval between data points may be fixed or variable (e.g., smaller intervals when the vehicle 100 is moving and greater intervals when the vehicle 100 is stationary), and may be based on time (e.g., every 100 ms) or distance (e.g., every 1 m) or both. In addition to defining the planned position of the vehicle 100, the output set of data may also define the planned speed, orientation, acceleration and/or angular speed of the vehicle 100 at each time point. Motion planning is repeatedly carried out (e.g., at time intervals of 100 ms), in order to be responsive to a rapidly changing environment. Generally, motion planning may be carried out at shorter time intervals than behavior planning and mission planning.

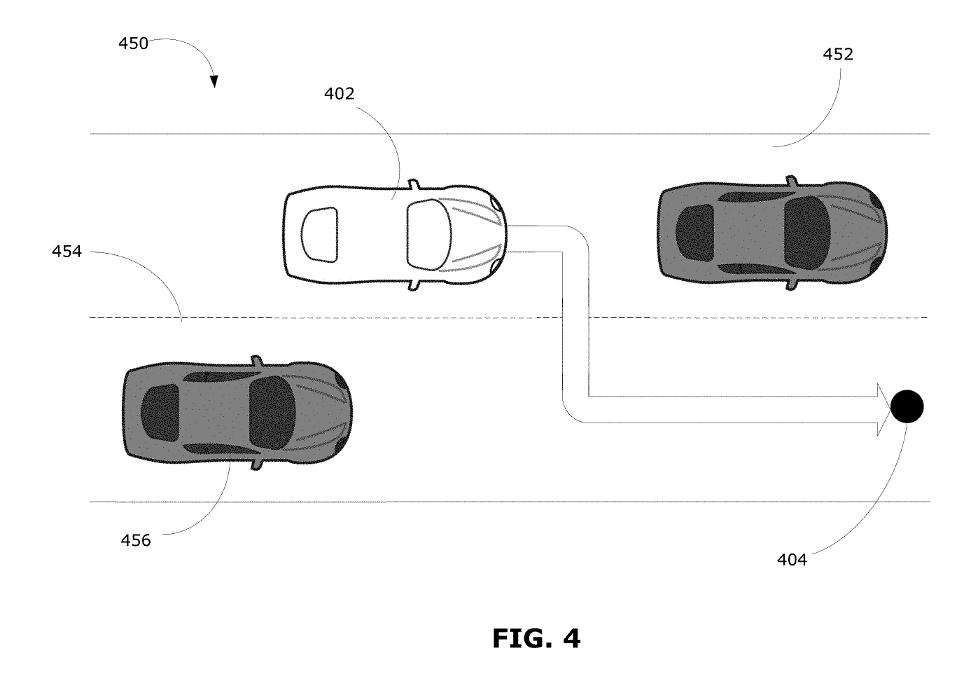

FIG. 4 illustrates an example of motion planning, which may be carried out by the path planning system 120 (e.g., using the motion planning unit 126). In this example, the target state 404 has been defined, for example based on the planned path from mission planning as well as from behaviour planning. In the example shown, the target state 404 is for the vehicle 100 to be in the rightmost lane, in order to make a right turn. The first state 402 of the vehicle 100 may be the current state of the vehicle 100, as determined by the sensor system 110. The first state 402 and target state 404 of the vehicle 100 may be defined similarly to that discussed above for behaviour planning. For example, the first state 402 may be defined not only as a position (e.g., x- and y-coordinates) but may also be defined by other parameters, such as the speed, orientation, acceleration and/or angular speed of the vehicle 100. The target state 404 may be similarly defined. Each point in the set of output data (including any intermediate states) may be defined by the same parameters. The search space for the bidirectional search includes these same parameters as search dimensions.

In the example shown, the sensed environment 450 includes the sensed drivable area, such as the paved roadway 452, road signage and markings, such as lane markings 454, and both stationary and moving obstacles, such as other vehicles 456. The sensor system 110 may sense information about obstacles including not only the current position and size of each obstacle, but also properties such as speed and orientation (in the case of moving obstacles), as well as possibly identification of the obstacle (e.g., there may be different path planning considerations if the obstacle is a bicycle instead of a car).

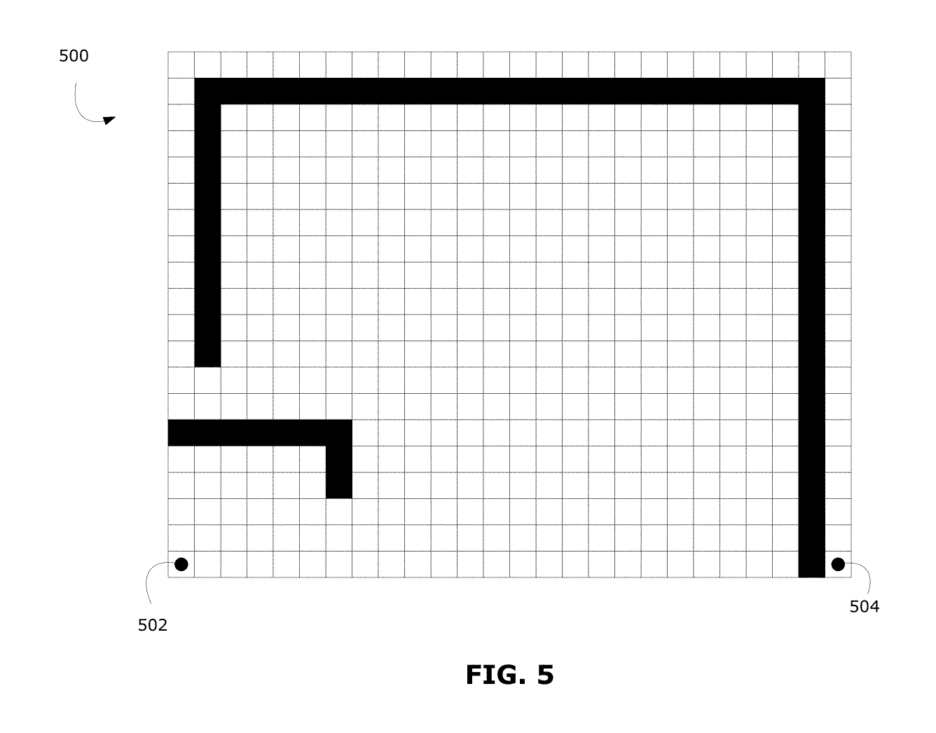

As mentioned above, path planning at the mission level and the motion level may be carried out using a bidirectional search. Generally, a bidirectional search is a search algorithm that finds a path from a starting state to a target state, where two searches are simultaneously performed from the starting state towards the target state (the forward search) and from the target state towards the starting state (the backward search). A successful search ends when the two searches meet up. An example of a suitable bidirectional search algorithm is described by Holte et al. in “Bidirectional Search That Is Guaranteed to Meet in the Middle” Thirtieth AAAI Conference on Artificial intelligence, 2016, incorporated herein by reference in its entirety. Other bidirectional search algorithms may be used. A bidirectional search is able to more quickly find a successful path from a starting state to a target state in a search space, compared to conventional unidirectional search methods, such as A* search. This is in part because, in many cases, a bidirectional search is able to find a successful path after searching a smaller subset of the search space, compared to unidirectional search methods. FIGS. 5-7 illustrate an example comparing the performance of an A* search to the performance of a bidirectional search.

FIG. 5 illustrates an example searchable grid map representing an environment to be travelled by the vehicle 100. The example map 500 is a simplified representation of the searchable map that may be searched during path planning at the mission level or at the motion level. For simplicity, the map 500 includes only x- and y-coordinates as searchable parameters. A start state 502 and a target state 504 are defined in the map 500. The map 500 defines drivable area (white squares) as well as non-drivable obstacles (black squares).

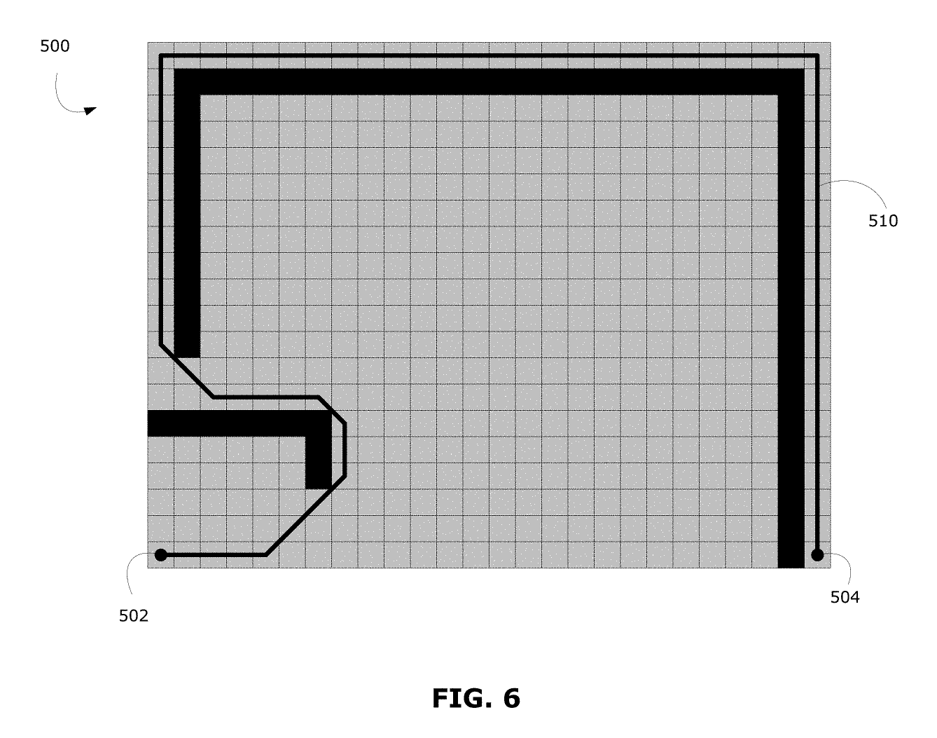

FIG. 6 illustrates the result of an A* search, which is an example of a unidirectional search, for a path 510 from the start state 502 to the target state 504. The grey squares indicate the areas of the map 500 that was searched during path planning. As can be seen from FIG. 6, although a path 510 was successfully found, all of the drivable area was searched.

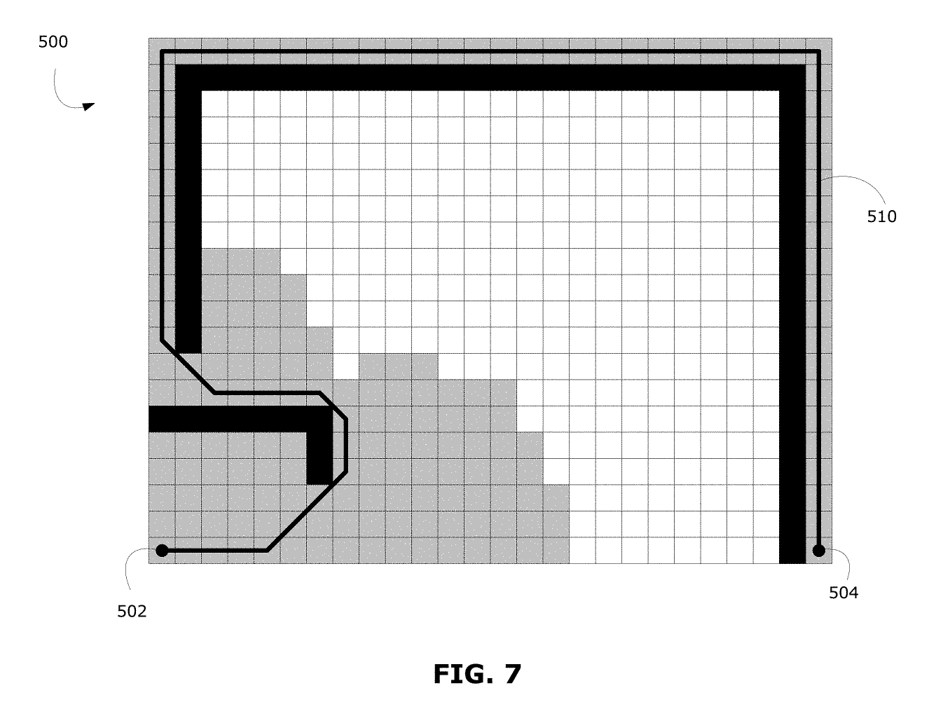

FIG. 7 illustrates the result of a bidirectional search in the same map 500. Using a bidirectional search, a forward search is performed from the start state 502 towards the target state 504, and simultaneously a backward search is performed from the target state 504 towards the start state 502. As can be seen from FIG. 7, the same path 510 was successfully found, however the searched portion (grey squares) of the map 500 represents a smaller subset of the search space, compared to that searched by A*.

A bidirectional search may be carried out for mission planning using a defined vehicle state (e.g., the vehicle's current state or expected future state) as the start state and the final destination as the target state. The search space may be at least partly defined by the drivable area (e.g., paved roadway) and any obstacles or detours, for example. The search space may also be at least partly defined by user-defined criteria, such as avoidance of toll roads. In the example of FIG. 2, the search space may be at least partly defined by the map 250 which indicates drivable roads. A bidirectional search may be carried out starting from the first state 202 and simultaneously starting from the target state 204, and may search different possible drivable areas until the forward search and the backward search meet, thus determining a successful path from the first state 202 to the target state 204 through the search space. The successful path is selected as the planned path generated by mission planning.

In some examples, mission planning may repeat the bidirectional search using different criteria (e.g., shortest expected time or shortest route), to generate multiple paths, for selection by the user. The user-selected path then becomes the planned path generated by mission planning. After the planned path has been generated, a set of one or more intermediate target states may be automatically defined along the planned path (e.g., at road intersections or at predetermined distance intervals).

A bidirectional search may be carried out for motion planning using a defined state of the vehicle, such as the vehicle's current state (e.g., as determined by the sensor system 110) or an expected future state of the vehicle as the start state. The target state may be a next intermediate state, as provided from a higher level of path planning (e.g., from behaviour planning), or the target state may be defined during motion planning as a point further along the planned path defined by a higher level of path planning (e.g., as defined by behaviour planning). The search space may be represented by the searchable map generated using information from the sensor system 110, as discussed above. In the example of FIG. 4, the search space may be represented by the searchable map that is generated from the sensed environment 450. A bidirectional search may be carried out starting from the first state 402 and simultaneously starting from the target state 404, until the forward search and backward search meet. The successful path is then generated as the planned path for motion planning.

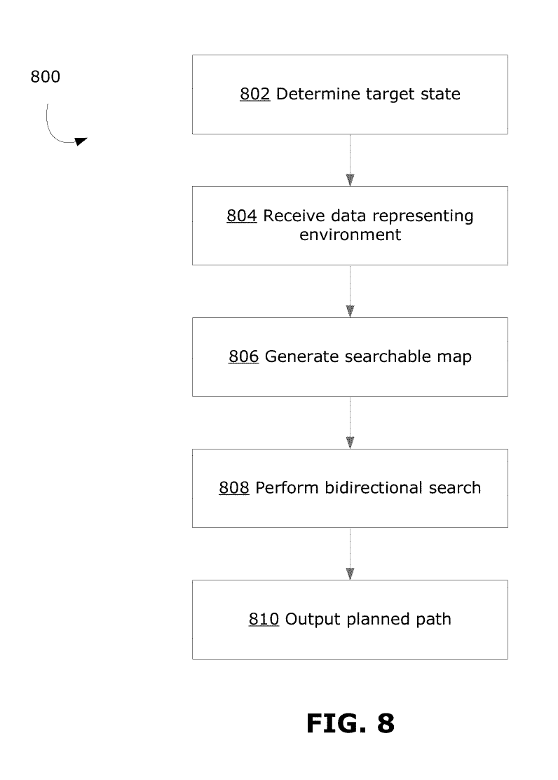

FIG. 8 is a flowchart illustrating an example method 800 for path planning in an autonomous vehicle, using bidirectional search. The method 800 may be used for mission planning as well as for motion planning, as discussed above.

At 802, a target state is determined. Determining the target state may include receiving input defining the target state. In the case of mission planning, the received input may be user input selecting a final destination point. In the case of motion planning, the received input may be output from a previous instance of path planning, for example an intermediate state defined at a higher level of path planning (e.g., at the mission or behaviour level). In motion planning, the target state may alternatively be determined by defining the target state as a point at a predetermined distance along the planned path from a first state, as discussed above.

At 804, data representing the environment of the vehicle is received. The environment of the vehicle may include the vehicle itself, and the data representing the environment may thus include data representing the state of the vehicle. The data representing the environment may be received from the sensor system. The data representing the environment may additionally or alternatively be received from an internal or external database (e.g., a map database). For mission planning, the data representing the environment may include data representing a location of the vehicle (e.g., GPS data) and geographical map data. For motion planning, the data representing the environment may include sensed data about the vehicle's immediate environment (e.g., drivable area and obstacles) as well as data representing a first state (e.g., a current state) of the vehicle (e.g., vehicle position, speed and orientation). In some examples, the first state of the vehicle may be determined based on user input or a prediction of the expected future motion and/or position of the vehicle, rather than the current state of the vehicle.

At 806, a searchable map is generated using the data representing the environment. The searchable map represents the space that is to be searched in order to generate a planned path. Generally, the search space for motion planning may have more dimensions than the search space for mission planning, because it may be more crucial to plan for a greater number of parameters in motion planning compared to mission planning.

At 808, a bidirectional search is performed. Any suitable algorithm for bidirectional search may be used. The path that is successfully found by the bidirectional search from the first state to the target state may be selected as the planned path. In some examples, the bidirectional search may be performed more than once, for example accordingly to different search criteria, and the planned path may be selected (e.g., according to user input) from among the results of the multiple bidirectional searches.

At 810, output defining the planned path is generated. For example, the planned path may be defined by a set of data points that define the state of the vehicle along the planned path. For mission planning, the output may define the location of the vehicle at different points along the planned path. In particular, the intermediate state of the vehicle may be defined at road intersections, in order to define the road(s) to be travelled on the planned path. For motion planning, the output may define the state of the vehicle at different time points along the planned path. For example, the planned position, orientation, speed and acceleration of the vehicle may be defined at intervals of every 100 ms along the planned path.

The generated output may be provided to the vehicle control system to control operation of the vehicle. The generated output may also be used for other instances of path planning (e.g., output from a higher level of path planning may be used as input for a lower level of path planning).

The method 800 may be performed iteratively for different levels of path planning, and may also be performed in parallel for different levels of path planning. For example, the method 800 may be performed repeatedly (e.g., at time intervals of 100 ms) for motion planning. The method 800 may also be performed for mission planning and subsequently for motion planning. The method 800 may also be carried out for mission planning and simultaneously for motion planning. Although described in a particular order of steps, the method 800 may be carried out in any suitable order of steps. For example, data representing the environment of the vehicle may be received prior to or in parallel to determination of the target state; or the first state of the vehicle may be determined prior to determination of the target state.

In examples described above, the position and/or orientation of the vehicle may be determined using GPS. In other examples, other methods (e.g., triangulation or position sensors) may be used. The position and/or orientation of the vehicle may be identified with varying levels of precision. For example, at the mission planning and behaviour planning levels, it may be sufficient to identify the start and/or target position of the vehicle generally (e.g., identification of the block, street or lane).

Although the present disclosure describes path planning as being carried out at the mission level, behaviour level and motion level, path planning need not be divided into these levels. The use of a bidirectional search for path planning may be used in path planning for autonomous vehicles in any implementation in which path planning involves searching a search space for a path between two points.

Various examples described herein provide methods and systems for path planning in an autonomous vehicle using bidirectional search. In some examples, the use of bidirectional search may increase the speed of path planning compared to conventional approaches. A bidirectional search approach may enable a suitable path to be determined by searching a smaller subset of the total search space, which may enable the search space to be increased (i.e., more parameters to be considered) and still be of practical use for autonomous vehicles.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for path planning in an autonomous vehicle, the method comprising:
receiving data representing an environment of the vehicle;
generating a searchable map of the environment using the received data;
performing a bidirectional search of the searchable map to determine a planned path from a first point in the searchable map to a second point in the searchable map, the first point representing a first state of the vehicle and the second point representing a target state of the vehicle; and
generating output including data defining the planned path.

2. The method of claim 1 wherein the output comprises a set of data defining a set of one or more intermediate states along the planned path.

3. The method of claim 2 wherein each of the one or more intermediate states is defined by one or more parameters including one or more of: vehicle position, vehicle speed, vehicle acceleration, vehicle orientation, vehicle angular speed or time.

4. The method of claim 1 wherein the data representing the environment includes data representing the first state of the vehicle, the method further comprising determining the first state of the vehicle using the data representing the environment.

5. The method of claim 1 further comprising determining the target state at least partly using output from a previous instance of path planning.

6. The method of claim 1 wherein the first state and the target state are each defined by one or more parameters including one or more of: vehicle position, vehicle speed, vehicle acceleration, vehicle orientation, vehicle angular speed or time; and wherein the searchable map includes the one or more parameters as search dimensions.

7. The method of claim 1 wherein the output is provided to a vehicle control system that controls operation of the vehicle.

8. The method of claim 1 wherein the received data is received from one or more sensors sensing the environment.

9. A system for path planning in an autonomous vehicle, the system comprising a processor configured to execute instructions to cause the system to:
receive data representing an environment of the vehicle;
generate a searchable map of the environment using the received data;
perform a bidirectional search of the searchable map to determine a planned path from a first point in the searchable map to a second point in the searchable map, the first point representing a first state of the vehicle and the second point representing a target state of the vehicle; and
generate output including data defining the planned path.

10. The system of claim 9 wherein the output comprises a set of data defining a set of one or more intermediate states along the planned path.

11. The system of claim 10 wherein each of the one or more intermediate states is defined by one or more parameters including one or more of: vehicle position, vehicle speed, vehicle acceleration, vehicle orientation, vehicle angular speed or time.

12. The system of claim 9 wherein the data representing the environment includes data representing the first state of the vehicle, wherein the processor is further configured to execute instructions to cause the system to determine the first state of the vehicle using the data representing the environment.

13. The system of claim 9 wherein the processor is further configured to execute instructions to cause the system to determine the target state at least partly using output from a previous instance of path planning.

14. The system of claim 9 wherein the first state and the target state are each defined by one or more parameters including one or more of: vehicle position, vehicle speed, vehicle acceleration, vehicle orientation, vehicle angular speed or time; and wherein the searchable map includes the one or more parameters as search dimensions.

15. The system of claim 9 being in communication with one or more sensors for obtaining the data representing the environment, wherein the data representing the environment is received from the one or more sensors.

16. The system of claim 9 being in communication with a vehicle control system for controlling operation of the vehicle, wherein the output is provided to the vehicle control system.

17. A vehicle comprising:
one or more sensors for obtaining data representing an environment of the vehicle;
a path planning system for generating a planned path to be travelled by the vehicle; and
a vehicle control system for controlling operation of the vehicle;
the path planning system being implemented by a processor executing instructions to cause the path planning system to:
receive, from the one or more sensors, data representing an environment of the vehicle;
generate a searchable map of the environment using the received data;
perform a bidirectional search of the searchable map to determine a planned path from a first point in the searchable map to a second point in the searchable map, the first point representing a first state of the vehicle and the second point representing a target state of the vehicle; and
provide, to the vehicle control system, output including data defining the planned path.

18. The vehicle of claim 17 wherein the output comprises a set of data defining a set of one or more intermediate states along the planned path, the one or more intermediate states being defined by one or more parameters including one or more of: vehicle position, vehicle speed, vehicle acceleration, vehicle orientation, vehicle angular speed or time.

19. The vehicle of claim 17 wherein the data representing the environment includes data representing the first state of the vehicle, wherein the processor is further configured to execute instructions to cause the path planning system to determine the first state of the vehicle using the data representing the environment.

20. The vehicle of claim 17 wherein the processor is further configured to execute instructions to cause the path planning system to determine the target state at least partly using output from a previous instance of path planning.

21. The vehicle of claim 15 wherein the first state and the target state are each defined by one or more parameters including one or more of: vehicle position, vehicle speed, vehicle acceleration, vehicle orientation, vehicle angular speed or time; and wherein the searchable map includes the one or more parameters as search dimensions.
